(19) United States
(12) Patent Application Publication
(10) Pub. No.: US 2012/0077397 A1
(43) Pub. Date: Mar. 29, 2012

(54) REINFORCING CARBON FIBERS AND MATERIAL CONTAINING THE FIBERS

(75) Inventor: John Frederick Porter, St. Catharines (CA)

(73) Assignee: SAINT-GOBAIN ADFORS CANADA, LTD., New York, NY (US)

(21) Appl. No.: 13/224,671

(22) Filed: Sep. 2, 2011

Related U.S. Application Data
(60) Provisional application No. 61/385,776, filed on Sep. 23, 2010.

(51) Int. Cl. D02G 3/02; D03C 13/00; D04H 13/00; B05D 1/34; D03D 15/00; D04B 21/00

(52) U.S. Cl. 442/51; 428/367; 442/188; 442/307; 427/407.1; 139/35

(57) ABSTRACT

A method for making a reinforcement material comprises providing at least one strand of carbon fibers. A polyolefin coating is applied. A coating comprising an inner layer of a first polyolefin material and an outer layer of a second polyolefin material may be coextruded on the at least one strand. The first polyolefin material has a substantially lower viscosity than the second polyolefin material at an extrusion temperature of the coextruding step. Alternatively, polyolefin fibers may be core sheath spun on the strands to coat the strands, and the coated strands of carbon fibers formed into a woven or knit fabric or a non-woven mesh for a reinforcing a material.

This application claims the benefit of U.S. Provisional Patent Application No. 61/385,776, filed Sep. 23, 2010, which is expressly incorporated by reference herein in its entirety.

### FIELD OF THE INVENTION

The present application discloses materials containing carbon fibers.

### BACKGROUND

Carbon fiber is becoming popular as a reinforcement component for materials ranging from cementitious substrates to high performance sailcloth. The fiber has a very high modulus, low creep and good UV resistance. A significant problem with carbon tow (the typical continuous untwisted filament strand) lies in handling problems. When carbon tow is processed in typical textile processing equipment (looms, knitters, laid scrim equipment) carbon fly (short fibers) are released into the airstream. The carbon fly can cause equipment damage. Carbon fly is electrically conductive. If even trace amounts of fly get into electrical or electronic equipment, electrical shorting can occur. There have been instances in which computers, motors and even entire factories have been shut down due to electrical and electronic failure.

### SUMMARY OF THE INVENTION

In some embodiments, a method for making a reinforcement material comprises providing at least one strand of carbon fibers; and cross-head extruding a coating comprising an inner layer of a first polyolefin material and an outer layer of a second polyolefin material on the at least one strand. The first polyolefin material has a substantially lower viscosity than the second polyolefin material at an extrusion temperature of the coextruding step.

In some embodiments, a method for making a reinforcement material comprises providing a plurality of strands of carbon fibers; core sheath spinning a polyolefin fibers on the strands to coat the strands, and forming the coated strands of carbon fibers into a woven or knit fabric or a non-woven mesh for reinforcing a material.

In some embodiments, a reinforcement fabric comprises at least one strand of thermoplastic coated carbon tow. The coating comprises an inner low viscosity layer and an outer high viscosity layer coextruded on the carbon fiber, the coated carbon tow suitable for use in a fabric or non-woven reinforcement material.

### BRIEF DESCRIPTION OF THE DRAWINGS

FIG. 1 is a cross sectional view of an exemplary coated carbon fiber.

FIG. 2 is a cross sectional view of an exemplary coated carbon strand.

FIG. 3 shows a non-woven mat formed of the coated carbon fibers.

FIG. 4 shows a woven fabric formed of the coated carbon fibers.

### DETAILED DESCRIPTION

This description of the exemplary embodiments is intended to be read in connection with the accompanying drawings, which are to be considered part of the entire written description. In the description, relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

To provide reinforcing fibers, individual carbon strands are coated with a thermoplastic resin, and then the coated strands are converted to fabric. In some embodiments, the resin is a polyolefin material. The material may include propylene or ethylene polymers or copolymers, or ethylene propylene copolymer for example. The fabric may be used as a reinforcement for cementitious material such as floor slabs on grade or facade reinforcement, or for other high-strength applications, such as sail cloth, for example.

The carbon fibers provide strength and alkali resistance, and the coating provides electrical insulation and moisture resistance. When the coated fibers (or woven fabric or non-woven mat made from the coated fibers) are used as a reinforcement, the coating provides a good mechanical bond between the fibers and the matrix, for load transfer and mechanical adhesion.

In some embodiments, the carbon tow has a single extruded coating cross-head extruded about the tow. In other embodiments, two concentric layers are cross-head extruded about the tow. In cross-head extrusion, the flow of plastic is typically altered for permitting the carbon tow to feed into the melt flow, and thus become part of the extrusion. Cross head extrusion does not require the carbon tow to pass through the extruder's barrel and screw. In various embodiments described below, cross-head equipment may be used for both single layer extrusion and coextrusion of plural layers.

The cross-head extrusion or spinning process (after heat consolidation of the spun fibers) provides the base fiber strand with a uniform coating of polymer. This coating provides a physical barrier to the entry of abrasive or alkaline materials which would otherwise attack and weaken the fibers. If a stiff fabric is desired, a stiff homopolymer of polypropylene may be used. If a more flexible coating is desired, a low density polyethylene polymer or an ethylene/propylene copolymer material may be used, for example.

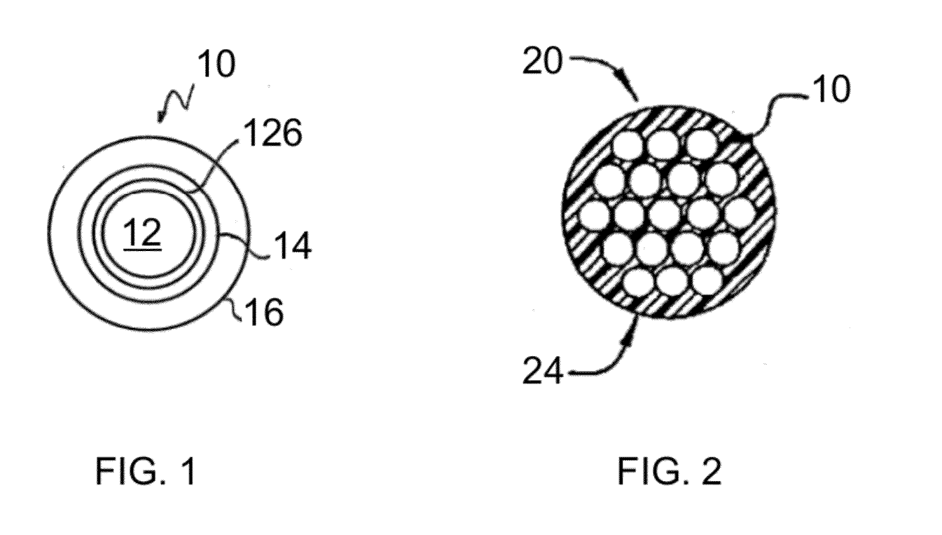

FIG. 1 is a cross sectional view of a coated carbon fiber 10. In some embodiments of a reinforcement for a cementitious material, at least one single-end coated carbon fiber 12 has a polyolefin coating 14, 16. The polyolefin coating comprises an inner low viscosity layer 14 and an outer high viscosity layer 16 coextruded on the carbon fiber 12. The inner low viscosity layer 14 wicks into the outer portion 12b of the carbon fiber 12. The single-end coated carbon fiber 10 is suitable for use in a fabric or non-woven reinforcement for cementitious materials.

In some embodiments, the inner layer 14 of the coating is partly wicked into the at least one strand of carbon fibers 12b. The inner layer 14 is selected to enhance bonding to the carbon fibers 12b, and the outer layer 16 is selected to bond to the matrix in which the fibers or fabric are to be included. In a coextrusion, the properties of each polymer layer can be targeted to the desired properties, and the location (relative to the fiber) of the material to provide those proerties. In some embodiments, desired mechanical adhesion and load transfer to the matrix is achieved using maleated polypropylene as the first polyolefin material 14. In some embodiments, the first polyolefin material 14 is a polypropylene homopolymer, and the second polyolefin material 16 is a maleated polypropylene. In other embodiments, at least one of the first and second polyolefin materials 14, 16 comprises low density polyethylene or an ethylene/propylene copolymer. In some embodiments, the second polyolefin material is more polar than the first polyolefin material.

In other embodiments, a single layer of maleated polypropylene provides the desired properties. This single layer can partially wick into the carbon tow and also provide good adhesion to a cementitious matrix.

FIG. 2 shows a coated strand 20, in which a plurality of fibers 10 are formed into a strand or yarn. The strand may optionally be heated to bond the outer polyolefin material layers 16 to form a sheath 24, or layer 24 may be applied as another separate coating of thermoplastic polymer.

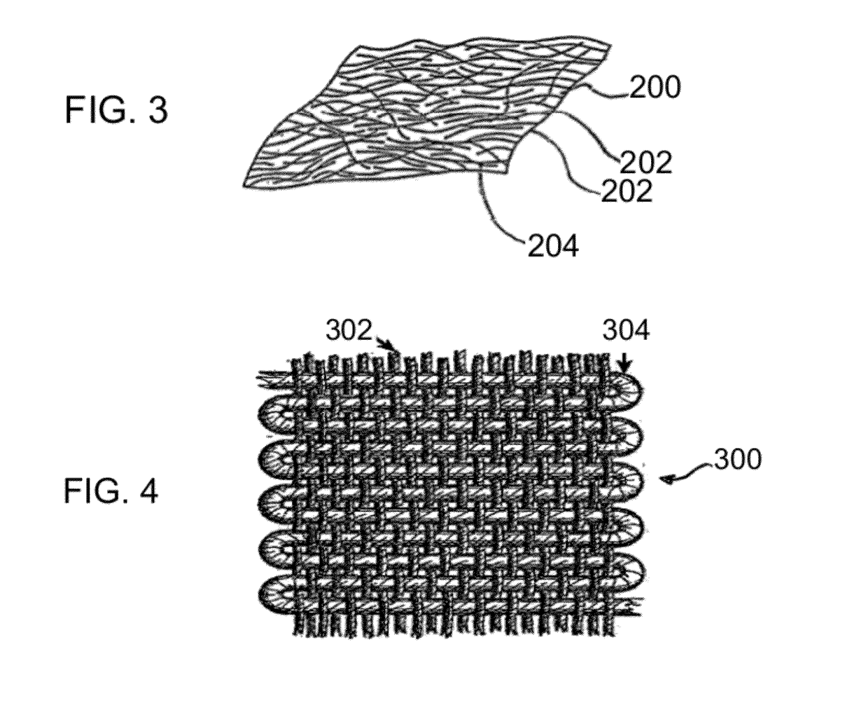

A plurality of strands of carbon fibers 10 may be formed into a reinforcing material by a variety of methods. As shown in FIG. 3, the fibers or strands may be laid in a non-woven mesh 200 having a plurality of fibers or strands 202 which are formed into a mat, and bonded, either by heating or by application of an optional binder 204. Alternatively, the fibers may be formed into a woven or knit fabric 300 as shown in FIG. 4. Fabric 300 may include warp fibers or strands 302 and weft fibers or strands 304. The fibers or strands, either in woven or non-woven form, are may be used for reinforcing a cementitious material. In some embodiments, the fabric formed from the fibers is used as a reinforcement for concrete pavement. The fabric may be used in place of or in addition to steel rebar or steel mesh. In some embodiments, one to nine inches of concrete are poured over the fabric.

### METHOD OF MANUFACTURE

The single ended coating 14, 16 may be extrusion coated onto the strands. In some embodiments, the strand is coated by coextrusion with two concentric layers 14, 16 of polymers simultaneously. The inside coating may be polypropylene homopolymer or ethylene-propylene copolymer, which -provides the mechanism to transfer stress or load from the outside to the fibers and makes the strand easy to handle in strand and subsequent fabric form. This also reduces moisture wicking in a wet environment. The outer coating may comprise a maleated polypropylene (maleic and hydride modified polypropylene) for example, or a polymer that is particularly suited for bonding to itself and to a matrix, such as a cementitious matrix.

In some embodiments, a cross-head extrusion or co-extrusion process is used. If a coextrusion process is used, the outer concentric layer 16 may be a polar polyolefin, such as maleated polypropylene or related carboxylated polymer.

In other embodiments, the outer coating may comprise a comingled strand such as “TWINTEX” fiber glass reinforced polypropylene composite material by OCV Reinforcements of Toledo, Ohio.

The base yarn or roving strand may be -carbon tow (continuous strands of carbon fibers). The coating serves to encapsulate the carbon to prevent carbon fly from contaminating the weave or knitting room and/or equipment. At the same time, the coating provides an alkalai barrier. In other embodiments, the base yarn may be E-glass or AR-glass based. The base strand may include commingled fibers, such as polypropylene and fiberglass.

The linear density of the base strand may be between 66 tex and 5000 tex. For concrete reinforcement, 600-1400 tex may provide a preferred material.

The coated strand is woven, knit or laid into a grid or mesh structure. The hole size of the mesh relates to the final end use. For example for regular Portland cement concrete (PCC), a 2.5 cm×2.5 cm (1″×1″) hole size may be used. For cementitious mortar reinforcement, a tighter mesh—e.g., 0.5 cm×0.5 cm (0.2″×0.2″) hole size may be used.

In some embodiments, the coating material provides 15% to 75% of the total weight of the coated fibers. In some embodiments, the coating material provides 20% to 50% of the total weight of the coated fibers. In some embodiments, the coating material provides 30% to 50% of the total weight of the coated fibers. In some embodiments, the coating is about 30% of the total weight.

In some embodiments, the same coated carbon fiber strands can be put it into a cement board or sailcloth. Advantages of carbon fiber-based racing sails include ultra-high modulus and elasticity, and ease of handling. The cloth may be used for other applications as well.

Some embodiments involve the extrusion coating of carbon tow (3K, 6K and 12K). In other embodiments, 24K or 48K carbon may be used. Cross-head extrusion quickly encapsulates the tow ensuring that no carbon fly can subsequently occur. The only airspace where the carbon fiber fly is significant enough to employ very good air handling is in the relatively small area behind the extruder. Further from the extruder, a less robust air handling system may be used.

The thermoplastic resin being extruded may be a low vinyl acetate (VA) ethylene vinyl acetate (EVA) resin, for example. Alternatively any thermoplastic resin could be used which is compatible with both the extrusion process and the laminating process of the laminator equipment.

Once the extrusion coating is completed, the coated carbon tow can be processed on any textile machine. The coated tows could then be used directly as input in a variety of processes without the further application of coatings. The EVA (for example) would then serve as both an encapsulant and a scrim binder.

Many variants are contemplated by the inventor as a substitute for extrusion coating. For example:

1. Core/sheath spinning in which the carbon tow comprises the core and a suitable thermoplastic staple fiber such as Polyethylene Terephthalate (PET), Polybutylene Terephthalate (PBT), PLA . . . form the sheath fiber. Such spinning equipment is commercially available, such as the Dref-2000 friction spinning machine sold by Fehrer GmbH of Austria. The equipment could be purchased or the fiber could be toll-processed by an existing spinner. Core sheath spinning is a textile process, where a core fiber or strand is provided, and then another fiber is spun around it. In some embodiments, the core is a first material and a different second material is spun around the core. For example, the core may be black carbon tow, and 1.5″ polypropylene fibers may be spun to form a sheathing over the core of the carbon. In some embodiments, the spun core and sheath are used in that form. In other embodiments, the core and sheathe are passed through heat to melt the polypropylene fibers so it becomes a continuous coating about the carbon.

2. Single-end coating with a water-based polymer or PVC or acrylic plastisol.

In some embodiments, a method for making a reinforcement for a material, comprises: providing at least one strand of carbon fibers; and coextruding a coating comprising an inner layer of a first polyolefin material and an outer layer of a second polyolefin material on the at least one strand.

In a method as described above, instead of moving the production line at a slow speed of 2 feet minute to 10 feet/minute (as in epoxy coated carbon fibers), the line speed can be operated on the order of 1,000 to 5000 feet/minute, because no curing time is involved. The thermoplastic coating is merely cooled, allowing more rapid production speeds.

Using a polyolefin coating material (e.g., polypropylene, polyethylene, EVA maleated polypropylene and/or ethylene propylene copolymers) the hardness and softness can be varied and controlled better than an epoxy coating. Further, with a polyolefin two strands can be laid at right angles to each other and heated to a temperature of about 250° F.-350° F., depending on the polymer type and polymer melt viscosity. for example, in some embodiments, about 320° F., to bond them together, because of the thermoplastic nature of the coating. This facilitates forming a mesh or grid from the coated fibers or strands in an efficient manner. One of ordinary skill in the art can use the welded grid for many applications, such as to replace a welded wire mesh in cementitious applications, to wrap concrete columns, or many other construction applications. Alternatively, the material can be woven into a sailcloth material.

In some embodiments, the first polyolefin material has a substantially lower viscosity than the second polyolefin material at an extrusion temperature of the coextruding step. For example, the viscosity of the first polyolefin material may be sufficiently low so that a portion of the first polyolefin material wicks into the at least one strand of carbon fibers. Melt flow rates from 10-1000 grams of polymer/10 minutes of flow time (inside layer) and 0.1-100 grams/10 minutes outside layer (if two layers are used) using a test according to ASTM D1238 or ISO 1133.

In some embodiments, a plurality of the strands of carbon fibers are provided, and the method includes weaving the coated strands into a fabric for reinforcing a cementitious material, such as pavement, concrete, floors and walls. In other embodiments, the strands are formed into a non-woven mesh reinforcement for cementitious material. In other embodiments, the strands are knit into a non-woven mesh reinforcement for cementitious material.

In some embodiments, plural types of coated carbon fiber strands are combined in a single mesh or woven fabric. For example, a mesh may include different types of polypropylene coated carbon fibers made by different processes or different structures. A first type of fiber in the mesh may include a low viscosity coating and a higher viscosity outer coating. A second type of fiber in the mesh may include a spun coating.

As described above, a thermoplastic “sheath” encapsulating the carbon tow prevents abrasion and carbon dust or carbon fly formation, eases of handling during fabric forming, and facilitates setting of the fabric by “re-activating” the coating after weaving or the like, to lock the strands together. Various embodiments include a single polymer layer, and optionally a second or co-extruded layer, depending on the end use.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A method for making a reinforcement material, comprising:
providing at least one strand of carbon fibers;
coextruding a coating comprising an inner layer of a first polyolefin material and an outer layer of a second polyolefin material on the at least one strand, the first polyolefin material having a substantially lower viscosity than the second polyolefin material at an extrusion temperature of the coextruding step.

2. The method of claim 1, wherein the viscosity of the first polyolefin material is sufficiently low so that a portion of the first polyolefin material wicks into the at least one strand of carbon fibers.

3. The method of claim 1, wherein the at least one strand of carbon fibers includes a plurality of strands of carbon fibers, the method further comprising weaving the coated strands into a fabric.

4. The method of claim 1, wherein the at least one strand of carbon fiber includes a plurality of strands of carbon fibers, the method further comprising forming the strands into a non-woven mesh reinforcement for cementitious material.

5. The method of claim 1, wherein the at least one strand of carbon fiber includes a plurality of strands of carbon fibers, the method further comprising knitting the strands into a non-woven mesh reinforcement for cementitious material.

6. The method of claim 1, wherein the first polyolefin material is a polypropylene homopolymer.

7. The method of claim 1, wherein the second polyolefin material is a maleated polypropylene.

8. The method of claim 1, wherein at least one of the first and second polyolefin materials comprises low density polyethylene or ethylene vinyl acetate.

9. The method of claim 1, wherein at least one of the first and second polyolefin materials comprises an ethylene/propylene copolymer.

10. The method of claim 1, wherein the second polyolefin material is more polar than the first polyolefin material.

11. A method for making a reinforcement material, comprising:
providing a plurality of strands of carbon fibers;
core sheath spinning polyolefin fibers on the strands to coat the strands; and
forming the coated strands of carbon fibers into a woven or knit fabric or a non-woven mesh for reinforcing a material.

12. The method of claim 11, further comprising heating the coated strands to fuse the polyolefin fibers before the forming step.

13. A method for making a reinforcement material, comprising:
providing a plurality of strands of carbon fibers;
cross head extruding a polyolefin on the strands to coat the strands, wherein the polyolefin has a viscosity sufficiently low so that a portion of the polyolefin wicks into the strands; and
forming the coated strands of carbon fibers into a woven or knit fabric or a non-woven mesh material.

14. The method of claim 13, wherein the coating provides 30% to 50% by weight of the coated strands.

15. A reinforcement, comprising:
at least one single-end coated carbon fiber having a polyolefin coating,
the polyolefin coating comprising an inner low viscosity layer and an outer high viscosity layer coextruded on the carbon fiber, the single-end coated carbon fiber suitable for use in a fabric or non-woven reinforcement material

16. The reinforcement of claim 15, wherein the inner layer of the coating is partly wicked into the at least one strand of carbon fibers.

17. The reinforcement of claim 15, wherein the at least one strand of carbon fibers includes a plurality of strands of carbon fibers, formed into a woven or knit fabric or a non-woven mesh for reinforcing a cementitious material.

18. The reinforcement of claim 15, wherein the first polyolefin material is a polypropylene homopolymer.

19. The reinforcement of claim 15, wherein the second polyolefin material is a maleated polypropylene.

20. The reinforcement of claim 15, wherein the second polyolefin material is more polar than the first polyolefin material.
